(19) United States
(12) Patent Application Publication
(10) Pub. No.: US 2026/0292589 A1
(43) Pub. Date: Sep. 24, 2026

(54) METHODS FOR TEMPORAL SPATIAL FREQUENCY (TSF) CHANNEL STATE INFORMATION (CSI) COMPRESSION AND ASSOCIATED HIDDEN BUFFER PARAMETER DETERMINATION

(71) Applicant: InterDigital Patent Holdings, Inc., Wilmington, DE (US)

(72) Inventors: Mohamed Salah Ibrahim, Chesterbrook, PA (US); Yugeswar Deenoo Narayanan Thangaraj, Chalfont, PA (US); Mihaela Beluri, Jericho, NY (US); Tejaswinee Lutchoomun, Montreal (CA); Akshay Malhotra, San Jose, CA (US); Patrick Tooher, Montreal (CA); Ahmet Serdar Tan, London (GB)

(73) Assignee: InterDigital Patent Holdings, Inc., Wilmington, DE (US)

(21) Appl. No.: 19/474,539

(22) PCT Filed: May 8, 2024
(86) PCT No.: PCT/US2024/028286

§ 371 Date: Oct. 10, 2025

Related U.S. Application Data
(60) Provisional application No. 63/465,075, filed on May 9, 2023.

(51) Int. Cl. H04W 28/06; H04W 24/08

(52) U.S. Cl. CPC H04W 28/06; H04W 24/08

(57) ABSTRACT

A wireless transmit receive unit (WTRU) may receive configuration information. The configuration information may be associated with preferred hidden buffer states for temporal-spatial-frequency (TSF) compression. The WTRU may determine a set of preferred hidden buffer states based on a plurality of historical channel state information (CSI) measurements and/or the configuration information. The set of preferred hidden buffer states may be based on squared generalized cosine similarity (SGCS) performance, an identified blockage event, physical downlink shared channel (PDSCH) performance, and/or an observation periodicity. The WTRU may send an indication for the set of preferred hidden buffer states to a network.

### CROSS-REFERENCE TO RELATED APPLICATIONS

This application claims the benefit of U.S. Provisional Patent Application No. 63/465,075 filed on May 9, 2023, the entire contents of which are incorporated herein by reference.

### BACKGROUND

Herein described are methods for a wireless transmit receive unit (WTRU) to reduce the channel state information (CSI) reporting overhead, e.g., using artificial intelligence/machine learning (AI/ML) models that may leverage the CSI temporal correlation properties.

As described herein, CSI may include at least one of the following: channel quality indicator (CQI), rank indicator (RI), precoding matrix index (PMI), an L1 channel measurement (e.g., reference signal received power (RSRP) such as L1-RSRP and/or signal interface and noise ratio (SINR)), channel state information reference signal (CSI-RS) resource indicator (CRI), synchronization signal physical broadcast channel (SS/PBCH) block resource indicator (SSBRI), layer indicator (LI), and/or any other measurement quantity measured by the WTRU from the configured reference signals (e.g., CSI-RS and/or SS/PBCH block and/or any other reference signal).

### SUMMARY

A wireless transmit receive unit (WTRU) may receive configuration information. The configuration information may be associated with preferred hidden buffer states for temporal-spatial-frequency (TSF) compression. The WTRU may determine a set of preferred hidden buffer states based on a plurality of historical channel state information (CSI) measurements and/or the configuration information. The set of preferred hidden buffer states may be based on squared generalized cosine similarity (SGCS) performance, an identified blockage event, physical downlink shared channel (PDSCH) performance, and/or an observation periodicity. The WTRU may send an indication for the set of preferred hidden buffer states to a network.

The configuration information may include a maximum hidden state buffer, one or more TSF parameters, a preconfigured performance threshold, a hidden buffer state monitoring periodicity, and/or an activation command to update the set of preferred hidden buffer states.

The WTRU may determine a preferred hidden buffer state out of a set of preferred hidden buffer states. The determination may be based on a measured performance metric and the preconfigured performance threshold. The WTRU may calculate compressed CSI based on the preferred hidden buffer state. The WTRU may send an indication for the preferred hidden buffer state used to compress the CSI to the network.

The WTRU may select one or more hidden buffer states to update based on a measured correlation coefficient relative to a configured threshold and/or based on a measured performance at each hidden buffer state.

The TSF parameters comprise number of buffer samples, TSF buffer state, compression rate (CR), TSF max buffer size, TSF buffer performance indicator, and/or input domain.

The WTRU may update the set of preferred hidden buffer states based on the measured correlation coefficient relative to a configured threshold and/or based on the measured performance at each state. The WTRU may store the updated set of preferred hidden buffer states in a hidden TSF buffer. The WTRU may send an indication for the updated set of preferred hidden buffer states to the network.

The WTRU may store a new hidden buffer state to the set of preferred hidden buffer states in the hidden TSF buffer when a number of time instances of successive recurrent neural network (RNN) operations is greater than a threshold.

The WTRU may store a new hidden buffer state to the set of preferred hidden buffer states in the hidden TSF buffer when the WTRU detects beam failure or radio failure.

The preferred hidden buffer states may include an intermediate representation of an input sequence, an internal memory state, a set of activations associated with one or more layers, and/or a state in a Markov decision process.

The hidden buffer may store one or more hidden states. The hidden states may include an intermediate representation of an input CSI sequence.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example of channel state information (CSI) measurement settings.

FIG. 3 depicts an example recurrent neural network (RNN) architecture.

FIG. 4 depicts an example of spatial frequency (SF) compression.

FIG. 5 depicts an example of time spatial frequency (TSF) compression using an RNN autoencoder TSF buffer.

FIG. 6 depicts an example realization of the hidden state framework.

### DETAILED DESCRIPTION

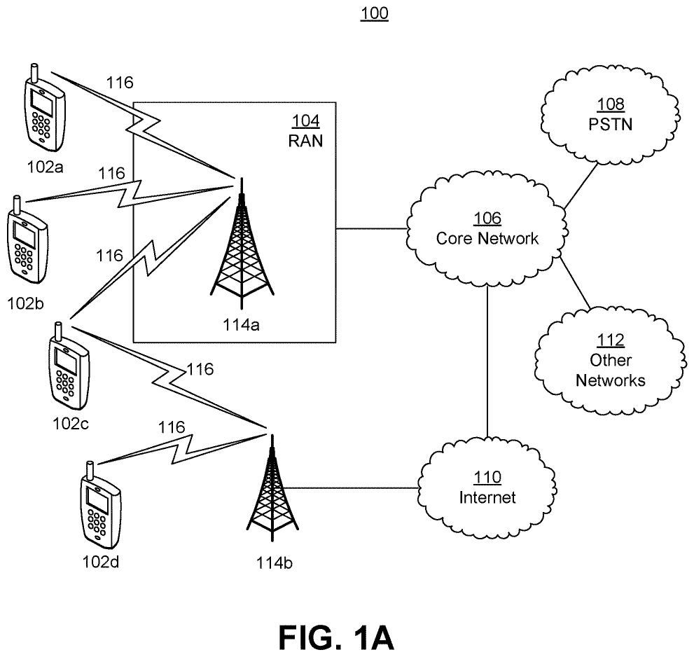

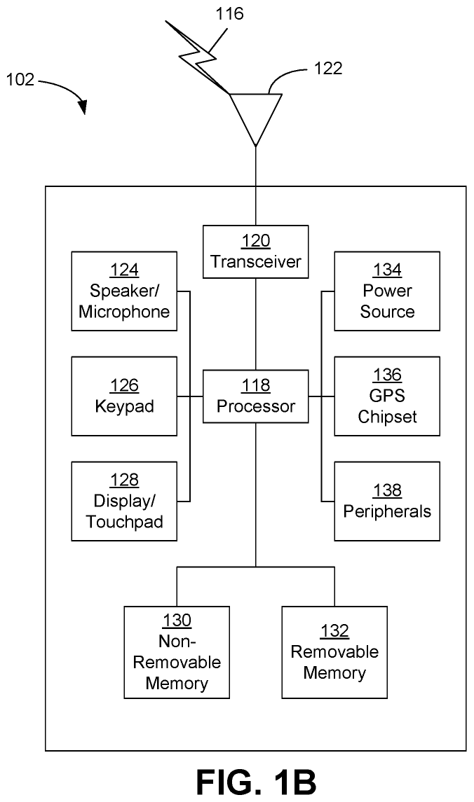

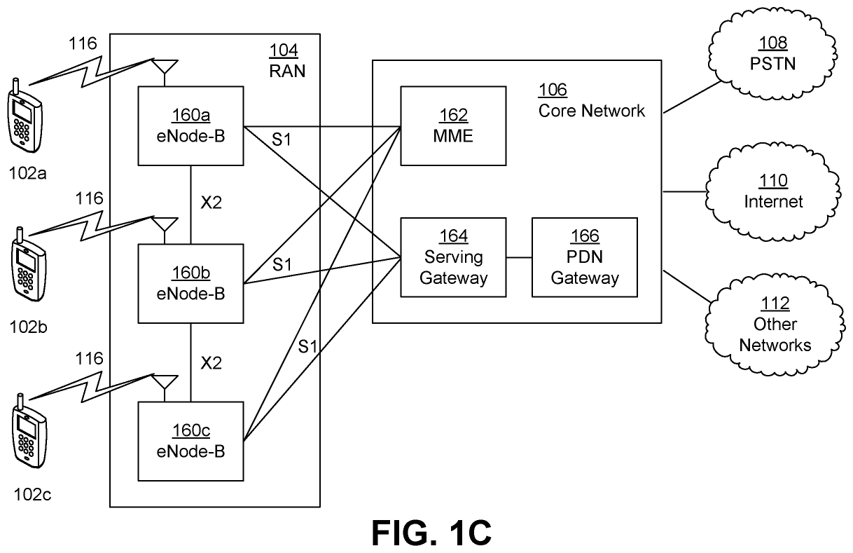

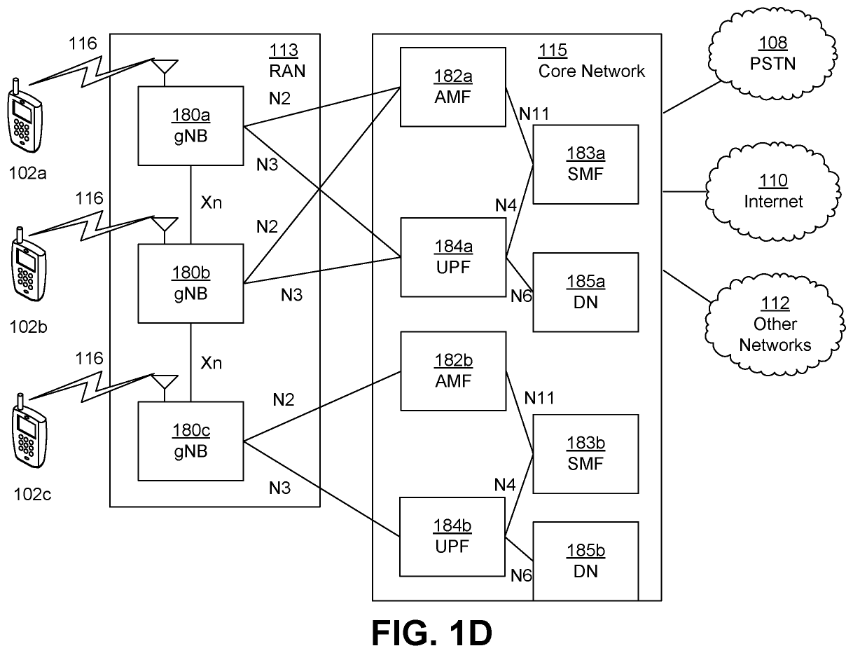

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU. Further, any description herein that is described with reference to a UE may be equally applicable to a WTRU (or vice versa). For example, a WTRU may be configured to perform any of the processes or procedures described herein as being performed by a UE (or vice versa).

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11 af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A wireless transmit/receive unit (WTRU) may determine parameters of temporal-spatial-frequency (TSF) compression as a function of channel conditions and/or configured metrics thresholds. The WTRU may report the determined TSF parameters. A WTRU may determine and/or report the next compression mode (e.g., TSF, SF, and/or none) as a function of channel conditions, configured metrics, thresholds, and/or current compression mode. A WTRU performing TSF domain channel state information (CSI) compression, may determine and/or report (e.g., a set of) preferred hidden buffer states as a function of metrics associated with the hidden buffer states and/or channel conditions (including identified blockage events). Procedures for detection and/or mitigation of out-of-sync events (e.g., misalignment between WTRU and/or network (NW) TSF buffers) by WTRUs performing TSF domain CSI compression.

A WTRU may report the CSI through the uplink (UL) control channel on physical uplink control channel (PUCCH), and/or based on (e.g., in response to) the gNBs' request on an UL physical uplink shared channel (PUSCH) grant. Depending on the configuration, channel state information resource signal (CSI-RS) may cover the full bandwidth of a bandwidth part (BWP) and/or just a portion of the BWP. Within the CSI-RS bandwidth, CSI-RS may be configured in each physical resource block (PRB) or every other PRB. In the time domain, CSI-RS resources may be periodic, semi-persistent, and/or aperiodic. Semi-persistent CSI-RS may be similar to periodic CSI-RS, except that the resource may be (de)-activated by medium access control (MAC) control elements (CEs), and/or the WTRU reports related measurements when the resource is activated. For aperiodic CSI-RS, the WTRU may trigger to report measured CSI-RS on PUSCH by request in a downlink control information (DCI). Periodic reports may be carried over the PUCCH. Semi-persistent reports may be carried either on PUCCH and/or PUSCH. The scheduler may use the reported CSI when allocating optimal resource blocks possibly based on channel's time-frequency selectivity, determining precoding matrices, beams, transmission mode, and/or selecting suitable modulation and coding schemes (MCSs). The reliability, accuracy, and/or timeliness of WTRU CSI reports may be critical to meeting ultra reliable and low latency communications (URLLC) service requirements.

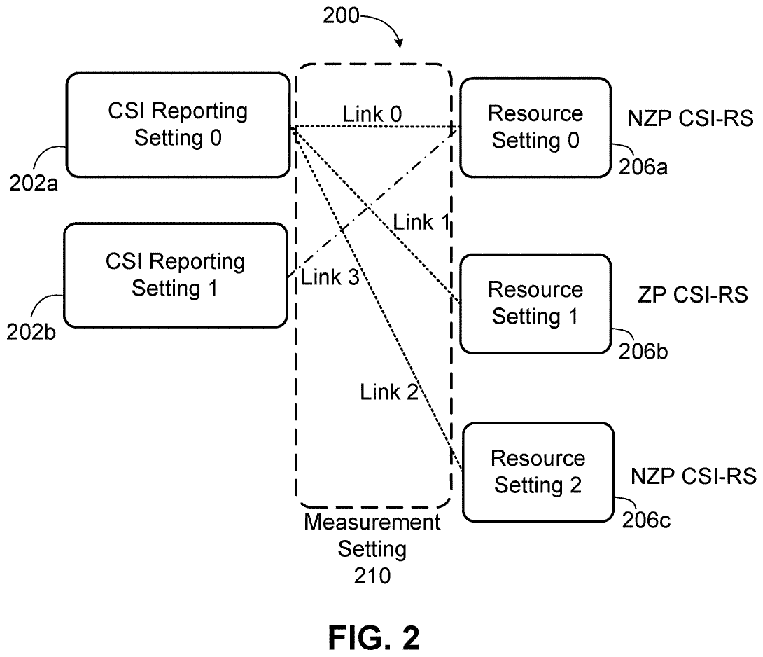

A WTRU may be configured with one or more CSI measurement setting 200. These settings may include one or more CSI reporting settings 202a, 202b, resource settings 206a, 206b, 206c, and/or a link 210 (e.g., association) between one or more CSI reporting settings and/or one or more resource settings. FIG. 2 Error! Reference source not found. depicts an example associated with a configuration for CSI reporting settings 202a, 202b, resource settings, and/or a link.

In the CSI measurement setting 200, one or more of the following configuration parameters may be provided: N≥1 CSI reporting settings, M≥1 resource settings 206a, 206b, 206c, and/or a CSI measurement setting link 210 which links the N CSI reporting settings 202a, 202b with the M resource settings 206a, 206b, 206c.

A CSI reporting setting 202a, 202b may include at least one of the following settings: time-domain behavior: aperiodic and/or periodic/semi-persistent; frequency-granularity, at least for precoding metric indicator (PMI) and/or channel quality indicator (CQI); CSI reporting type (e.g., PMI, CQI, RI, and/or CSI reference signal resource indicator (CRI), etc.); and/or PMI type (e.g., type | and/or type II) and/or codebook configuration if a PMI is reported.

A resource setting 206a, 206b, 206c may include at least one of the following settings: time-domain behavior, e.g., aperiodic and/or periodic/semi-persistent; reference signal (RS) type (e.g., for channel measurement and/or interference measurement); and/or S≥1 resource set(s) and/or each resource set can include Ks resources.

A CSI measurement setting 200 may include at least one of the following settings: one CSI reporting setting 202a, 202b; one resource setting 206a, 206b, 206c; and/or for CQI, a reference transmission scheme setting.

For CSI reporting for a component carrier, one or more of the following frequency granularities may be supported: wideband CSI, partial band CSI, and/or sub band CSI.

Artificial intelligence may be broadly defined as the behavior exhibited by machines. Such behavior may, e.g., mimic cognitive functions to sense, reason, adapt, and/or act. The terms artificial intelligence (AI), machine learning (ML), deep learning (DL), and/or deep neural networks (DNNs) may be used interchangeably. Methods described herein may be based on learning in wireless communication systems. These methods may not be limited to such scenarios, systems, and/or services and/or may be applicable to any type of transmissions, communication systems and/or services, etc.

Auto-encoders (AE) may be a specific class of DNNs that arise in context of unsupervised machine learning setting wherein high-dimensional data may be non-linearly transformed to a lower dimensional latent vector using a DNN based encoder. The lower dimensional latent vector may then reproduce the high-dimensional data using a non-linear decoder. The encoder may be represented as E(x; Wₑ) where x is the high-dimensional data and Wₑ may represent the parameters of the encoder. The decoder may be represented as D(z; W_{d}) where z may be the low-dimensional latent representation and W_{d} represents the parameters of the decoder. Further, using training data {x₁, . . . , x_{N}} the auto-encoder may be trained by solving the following optimization problem:

$$\{ {W}_{e}^{t r} , {W}_{d}^{t r} \} = arg {min}_{{W}_{e} , {W}_{d}} {\sum }_{i = 1}^{N} {‖ {x}_{i} - D ( E ( {x}_{i} ; {W}_{e} ) ; {W}_{d} ) ‖}_{2}^{2} .$$

The above problem may be approximately solved using a backpropagation algorithm. The trained encoder

$$E ( x ; {W}_{e}^{t r} )$$

may compress the high-dimensional data. The trained decoder

$$D ( z ; {W}_{d}^{t r} )$$

may decompress the latent representation.

Recurrent neural networks (RNN) may have recently emerged as a popular approach for handling problems with time series data due to their power in uncovering complex relationships between temporal components in a given sequence. RNNs may be another class of DNNs consisting of an input layer, an output layer, and/or one or more hidden layers. The hidden layers may leverage memory of previous states to perform compression and/or prediction tasks.

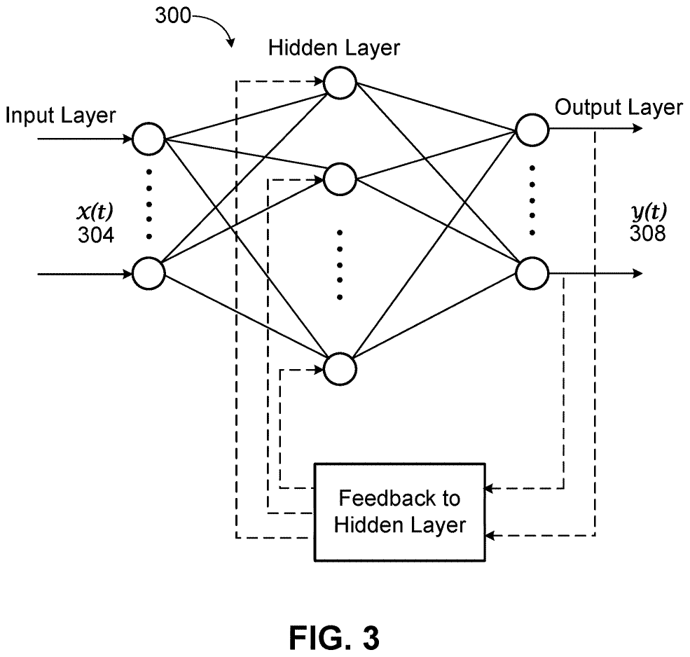

FIG. 3 depicts an example RNN architecture 300. As illustrated in FIG. 3, the vector of hidden states may be a function of current inputs and/or previous RNN output, x, also referred to herein as x (t), represents the at the RNN input vector 304 at time t, and/or y, also referred to herein as y (t) represents the RNN output vector 308 at time t.

An RNN may perform CSI compression tasks. When the RNN is used for channel/CSI compression, the input x 304 may consist of a sequence of N previous consecutive channel estimates represented by:

$$\tilde{H} ( t ) , \tilde{H} ( t - 1 ) , … \tilde{H} ( t - N + 1 ) .$$

To generate the RNN input, the estimated channel and/or CSI may be fed to a tapped delay line. Moreover, depending on the RNN architecture, the input sequence of N channel estimates may be converted from matrix to vector form. For an AE model with RNN structure, the encoder output may represent the latent compressed channel and/or CSI at time t, (e.g., zₜ), generated based on a sequence of input channel samples. The decoder output may represent the decompressed channel at time t given the latent zₜ along with the N previous consecutive decompressed channel estimates represented by:

$$\hat{H} ( t - 1 ) , … \hat{H} ( t - N + 1 ) .$$

An example of loss function used to train the RNN is

$$ℒ = {‖ \hat{H} ( t ) - H ( t ) ‖}_{F}^{2} ,$$

where Ĥ(t) represents the output of the decoder at time t, H(t) represents the desired output of the network (e.g., the actual channel at time t), and/or the operator ∥·∥_{F} indicates the Frobenius (e.g., Euclidean) norm.

Machine learning based approaches (e.g., AE) may be used to balance CSI feedback overhead and/or reconstruction performance. Certain machine learning techniques may rely on spatial-frequency (SF) CSI compression (e.g., using the estimated channel sample at a given time). SF compression may provide acceptable reconstruction quality. The reconstruction quality performance may be improved. The reconstruction quality may approach the reconstruction quality performance of uncompressed CSI.

The performance of CSI compression may be improved by leveraging the correlation properties of the channel in the compression process. For example, the CSI temporal correlation may be exploited on the top of SF compression, which may improve the reconstruction performance for a given overhead, reduce the overhead for a given performance, and/or improve performance and/or overhead relative to the SF compression.

However, to optimize the performance of the time-spatial-frequency (TSF) approach, the encoder and/or decoder may need to operate in a synchronous mode (e.g., the RNN encoder and/or decoder parameters (e.g., buffer size) are matched). The techniques described herein may be used to provide seamless and/or efficient TSF operation.

The following problems may be addressed: for an AE with RNN architecture at both encoder and decoder, how to adapt the number of temporal samples in the encoder and/or decoder to achieve a target performance; how to determine which compression mode (TSF, SF, none) to use; how to determine and indicate the TSF parameters (e.g., number of buffer samples (N), buffer state, compression rate (CR), etc.) associated with the TSF compression mode(s); how to revisit and/or indicate a particular hidden state in the encoder and/or decoder buffer to maintain a target performance; how to maintain the synchronous operation of the RNN AE by detecting/minimizing the out-of-sync events (e.g., synchronization loss between the RNN encoder and decoder), and/or how to mitigate the associated impacts.

Although examples described herein are in the context of recurrent neural networks (RNNs), the techniques are generally applicable to any type of artificial intelligence/machine learning (AI/ML) model including, but not limited to, long short-term memory (LSTM), gated recurrent units (GRU), attention-based models (e.g., transformers), and/or AE models (e.g., variational autoencoders, conditional variational autoencoders, etc.).

An RNN AE may include an AE model with RNN based architecture at the encoder and/or decoder parts of the AE model. The encoder and/or decoder may be referred to as RNN encoder and/or RNN decoder. The RNN architecture may be used to incorporate the past and/or historical samples in the compression and decompression tasks.

SF compression may include a compression technique that compresses the current CSI sample (e.g., raw channel and/or eigenvector) using an encoder model at the WTRU, and/or uses the compressed CSI to recover the decompressed CSI using a decoder model at the gNB.

TSF compression may include a compression technique that utilizes at least past and/or historical CSI samples (e.g., raw channel and/or eigenvector) along with the current CSI sample(s) at the WTRU to generate the current compressed CSI using RNN encoder. TSF compression may further include at least one past and/or historical decompressed CSI sample along with the current compressed CSI at the gNB to generate and/or recover the current decompressed CSI using the RNN decoder.

Modes may be used to distinguish between the different compression techniques. For example, the compression mode may be TSF, SF, and/or another compression type (e.g., CSI type I codebook and/or CSI type II codebook).

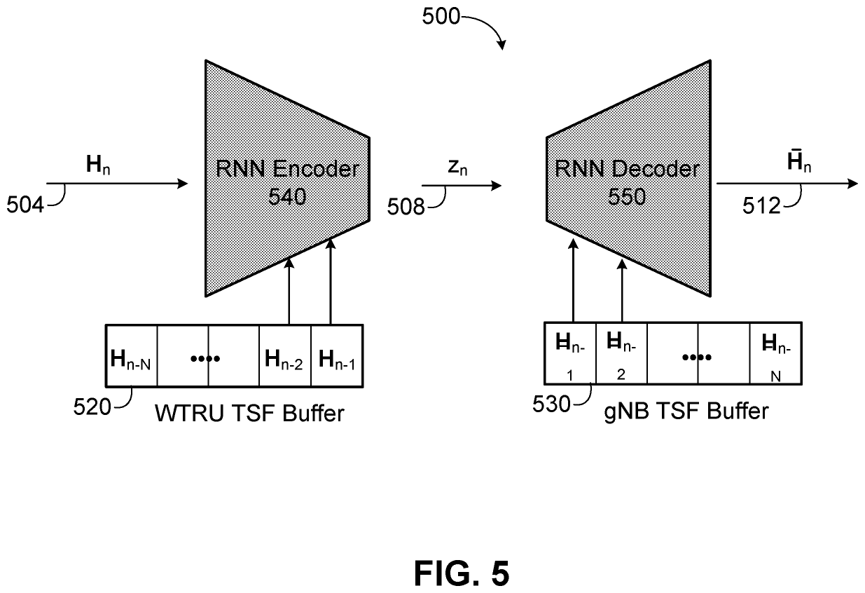

The term TSF buffer may refer to the buffer used at the WTRU to store the past CSI samples (e.g., raw channel and/or eigenvector) and/or the buffer used at the gNB to store the past decompressed CSI samples. The term WTRU TSF buffer may also be used to refer to the TSF buffer at the WTRU. The term gNB TSF buffer may also be used to refer to the TSF buffer at the gNB, as shown in FIG. 5. The terms TSF buffer and TSF history buffer may be used interchangeably herein.

The term hidden state X may refer to an internal and/or hidden state of the RNN encoder and/or RNN decoder that includes an intermediate representation of a sequence of X historical samples. For example, given a sequence of CSI samples H(5), H(4), . . . H(1) collected across five time slots, the hidden state 5 may include the information associated with h₅, which may serve as an intermediate representation of the channel samples collected up to slot 5.

A TSF hidden buffer may refer to the buffer used at the WTRU to store the information associated with one or more of the hidden states. A TSF hidden buffer may refer to the buffer used at the gNB to store the information associated with the hidden states representing a sequence of decompressed CSI samples.

RNN AE synchronous operation may refer to a synchronized operation between the RNN encoder and/or the RNN decoder. Synchronization between the RNN encoder and/or RNN decoder may include one or more of the following: the RNN encoder and/or decoder TSF buffers are synchronized, (e.g., the same number and/or indices of historical samples may be stored and used during inference at both WTRU and/or gNB); and/or the RNN encoder and/or decoder hidden buffers may be synchronized, (e.g., the same hidden state indices may be stored in the two hidden buffers and/or the same state index may be used during inference at both sides).

Out-of-sync events may refer to the loss of synchronization between the RNN encoder and/or RNN decoder. For example, when there is any misalignment in the TSF buffers and/or TSF hidden buffers, an out-of-sync event may occur (e.g., the RNN encoder and/or RNN decoder may be out-of-sync).

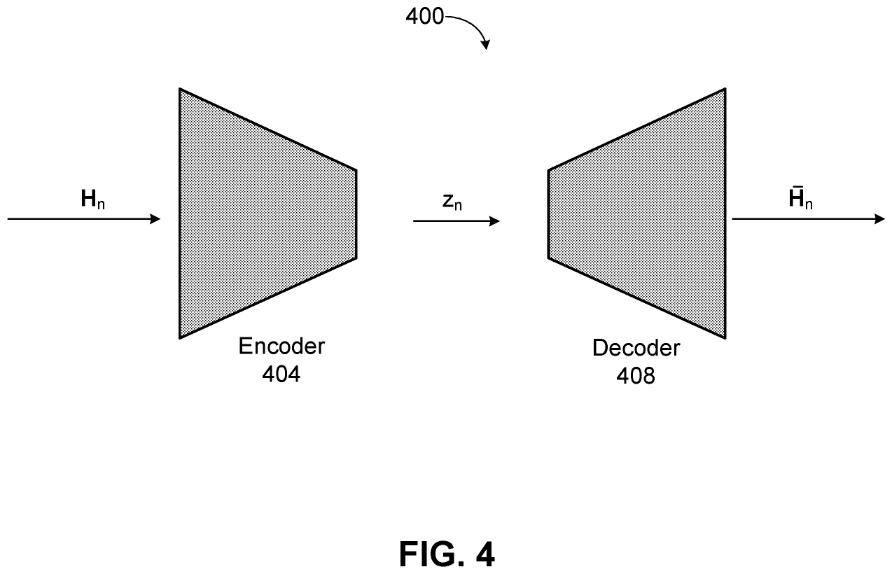

Spatial frequency (SF) compression may operate on a sample-by sample basis. A WTRU may use an AE model to perform compression at time slot n, e.g., based on the estimated channel Hₙ. In examples, the WTRU may compress (e.g., first compress) Hₙ using an encoder model to generate and/or send back the latent representation (e.g., compressed CSI) zₙ: The gNB may use the decoder model to decompress the received latent zₙ to recover H̅ₙ. The difference and/or distance between the estimated channel Hₙ at the WTRU and the recovered and/or decompressed channel at the gNB may represent the compression loss. FIG. 4 depicts an example diagram 400 of the SF compression.

Certain encoder 404 and/or decoder 408 models may incorporate historical time samples. In such a case, for example, AE models may be referred to as RNN autoencoder (e.g., where both encoder 404 and/or decoder 408 may have RNN architecture). Such a compression mode may be referred to as TSF compression.

In TSF compression, past samples may be used as an input along with the current sample as shown in the diagram 500 in FIG. 5. As illustrated in FIG. 5, the CSI temporal correlation properties may be leveraged to further improve the compression performance. The compression performance may improve from an overhead reduction perspective for a given performance, from a reconstruction performance perspective for a given overhead, and/or by achieving gains in both overhead reduction and/or reconstruction performance.

As further described herein, TSF may leverage the CSI temporal correlation properties to enable high compression capabilities relative to the SF and/or other compression techniques (e.g., CSI type I codebook and/or CSI type II codebook) for a given target performance. TSF may leverage the CSI temporal correlation properties which may improve the performance of SF and/or other compression techniques at a given compression rate. TSF may provide both performance and/or overhead reduction gains relative to SF and other compression techniques. TSF may provide dynamic adaptation and/or flexible use of the past historical samples to balance between performance, complexity, overhead, and/or storage.

A WTRU may determine parameters of temporal-spatial-frequency (TSF) compression as a function of channel conditions and/or configured metrics thresholds and/or reports the determined TSF parameters. A WTRU may determine and/or report the next compression mode (e.g., TSF, SF, and/or none) as a function of channel conditions, configured metrics, thresholds, and/or current compression mode. A WTRU performing TSF domain channel state information (CSI) compression, determines and/or reports (e.g., a set of) preferred hidden buffer states as a function of metrics associated with the hidden buffer states and/or channel conditions (including identified blockage events). Procedures for detection and mitigation of out-of-sync events (e.g., misalignment between WTRU and/or network (NW) TSF buffers) by WTRUs performing temporal-spatial-frequency (TSF) domain CSI compression.

A WTRU may determine the parameters associated with TSF compression, e.g., as a function of channel conditions and/or configured metrics thresholds. The WTRU may report the determined TSF parameters (e.g., to the network, for example, to maintain synchronicity).

The WTRU, in a system using two-sided models for CSI compression, may perform TSF domain compression. The TSF configuration may include one or more TSF parameters, such as: maximum TSF buffer size for past CSI, where the TSF buffer includes historical CSI (e.g., eigenvector samples and/or full CSI samples); initial compression ratio (e.g., if two or more RNN encoders are used); and/or metric threshold for use of TSF (e.g., TSF squared generalized cosine similarity (SGCS). The WTRU may measure the CSI and/or store the measured CSI (e.g., full channel) in the TSF buffer.

The WTRU may determine the TSF parameters. The TSF parameters may include: the TSF maximum buffer size; TSF buffer performance indicator for each size (e.g., SGCS); TSF buffer state; selected compression rate; metric (e.g., SGCS); and/or input domain (e.g., eigenvector versus CSI). For example, the WTRU may determine the TSF parameters based on one or more of the following: metric threshold, WTRU speed, and/or PDSCH performance.

As described herein, the WTRU may determine TSF parameters based on a metric threshold. In such case, the WTRU may measure the SGCS between consecutive samples and/or measure the SGCS between the first and/or last samples in the TSF buffer. The WTRU may compare the SGCS to the configured TSF SGCS threshold.

As described herein, the WTRU may determine TSF parameters based on the WTRU's speed. In such case, the WTRU may determine the maximum buffer size based on the estimated Doppler, feedback delay and/or CSI processing time.

As described herein, the WTRU may determine TSF parameters based on the PDSCH performance. In such case, the WTRU may update TSF parameters (e.g., reduce compression ratio) if block error rate (BLER) exceeds a certain configured threshold.

The WTRU may calculate the compressed CSI using the determined parameters (e.g., TSF buffer size and/or selected compression ratio). The WTRU may report the determined TSF parameters (e.g., TSF buffer size, TSF buffer performance indicator, selected compression rate, input domain, and/or TSF buffer state) and/or the compressed CSI.

A WTRU may determine and/or report the next compression mode (e.g., TSF, SF, or none) as a function of channel conditions, configured metrics thresholds, and/or current compression mode.

The WTRU (e.g., a WTRU in a system using two-sided models for CSI compression) may determine the next compression mode (e.g., TSF, SF, or none). For example, the configuration may include: compression mode specific parameters, initial compression ratio, metrics for compression mode determination (e.g. SGCS), and/or a threshold or set of thresholds for compression mode determination (e.g., TSF SGCS).

The WTRU may measure the CSI. The WTRU may perform measurements (e.g., when triggered) for compression mode determination. For example, the WTRU may measure the SGCS between the current sample CSI and/or a previous CSI sample. Additionally or alternatively, the WTRU may measure the SGCS between the first and last CSI samples in the TSF history buffer.

The WTRU may determine the next compression mode (e.g., TSF, SF, or none) as a function of the channel conditions, configured metrics thresholds, and/or the current compression mode. For example, the WTRU may determine the next compression mode as TSF if the current mode is SF and/or the measured performance metric exceeds a first configured threshold. Additionally or alternatively, the WTRU may determine the next compression mode as SF if the current mode is TSF and the measured performance metric is below a second configured threshold. Additionally or alternatively, the WTRU may determine the next compression mode as SF if the WTRU speed exceeds a configured threshold.

The WTRU may calculate the compressed CSI. The WTRU may report the next compression mode and the associated parameters, and/or the compressed CSI.

One or more of the following may apply to the compression mode determination when current mode is SF: The WTRU may measure the CSI. The WTRU may measure the SGCS between the current CSI sample and previous CSI samples. The WTRU may perform CSI compression based on the current compression mode (e.g., SF). On a condition that the measured SGCS exceeds a first threshold, the WTRU may set the next compression mode to TSF. On a condition that the measured SGCS is less than the first threshold, the WTRU may set the next compression mode to SF. The WTRU may report the next compression mode and the compressed CSI.

One or more of the following may apply to compression mode determination when current mode is TSF: The WTRU may measure the CSI. The WTRU may update the TSF history buffer. The WTRU may measure the SGCS between the first and/or last CSI sample in the TSF buffer. On a condition that the measured SGCS is less than a second threshold, the WTRU may reset the TSF history buffer, set the next compression mode to SF, and/or perform the SF mode CSI compression.

On a condition that the measured SGCS may be larger than a second threshold, then the WTRU may set the next compression mode to TSF, perform TSF mode CSI compression, and/or may update the TSF parameters when triggered. The WTRU may report the next compression mode and/or the compressed CSI.

A WTRU performing TSF domain CSI compression may determine and/or report (e.g., a set of) preferred hidden buffer states The WTRU may determine a set of preferred hidden buffer states as a function of one or more metrics associated with the hidden buffer states and/or channel conditions (e.g., including identified blockage events).

The WTRU performing TSF domain compression may determine and/or report preferred hidden buffer states. For example, the configuration may include one or more of: a maximum hidden state buffer size, such as the maximum number of hidden states to store, wherein hidden state X denotes an intermediate/hidden representation of a sequence of X historical CSI samples (e.g., raw CSI and/or eigenvector); one or more TSF parameters (e.g., TSF buffer maximum size); preconfigured performance threshold (e.g., TSF SGCS); hidden states monitoring/observation periodicity (e.g., X ms); and/or activation for selecting/recommending the preferred hidden state.

The WTRU may determine a (e.g., a set of) preferred hidden state(s) to store in the hidden buffer based on the SGCS performance, an identified blockage event, the PDSCH performance, and/or an observation periodicity. The WTRU may update the performance information (e.g., SGCS) associated with each preferred hidden state. The WTRU may update (e.g., add, remove, and/or replace) the preferred hidden state based on WTRU's speed and/or a configured periodicity for a state to become obsolete.

The WTRU may determine (e.g., identify) which hidden state to revisit based on the measured correlation coefficient relative to the configured threshold. Additionally or alternatively, the WTRU may determine (e.g., identify) which hidden state to revisit based on the measured performance at each state.

The WTRU may calculate the compressed CSI based on the selected hidden state. The WTRU may report (e.g., the network) an indication of the preferred hidden states and/or associated parameters (e.g., associated performance and/or state update message) to update the hidden state buffer. For example, the indication may include the selected hidden state to apply (e.g., selected state ID, performance, etc.). The WTRU may report the compressed CSI using the selected hidden state.

As described herein, when RNNs are used as examples, the techniques are not limited to just RNNs. Rather, techniques may apply to any type of AI/ML model including, but not limited to: long short-term memory (LSTM), gated recurrent units (GRU), attention-based models (e.g., transformers), AE models (e.g., variational autoencoders and/or conditional variational autoencoders, etc.). The terms TSF hidden state and hidden state, may be used interchangeably herein.

Although the methods described herein apply the CSI compression use case as an example, the examples may not be limited to CSI compression. Rather, broadly consider the methods as they may apply for any use case. As described herein, the term hidden state may refer to intermediate representation of an input sequence(s). The input may be latent vector, CSI samples, eigenvectors, raw channels and/or any preprocessed versions thereof. Representation herein may include one or more of a low or high dimensional representation, a compressed representation, encoded representation, non-linear transformation, a summary of previous input sequence(s), a belief about future sequence(s), a temporal dependency information, a correlation information, and/or extracted, aggregated, and/or selected feature information. Hidden state may also refer to internal memory state; for example, an internal state of an AI model that corresponds to information from the past sequence(s) and/or inference(s). Hidden state may also refer to a set of activations associated with one or more layers (e.g., a hidden layer) of the AI/ML model at specific time step during inference. Hidden state may correspond to state as in Markov decision process.

The hidden state may capture the relevant and/or important information from the previous input and/or representation thereof which may be useful for subsequent inference.

The output of an Al/ML model may be a function of input applied to the model and/or the hidden state of the model at the time of inference. The hidden state itself may be a function of previous input. The hidden state may be initialized to a configured value (e.g., during initial inference and/or when a hidden state revisited based on one or more examples described herein).

The exact value of hidden state may be different for the model at the WTRU and/or the model at the NW. Hidden state at the WTRU side model may associate with corresponding hidden state at the NW side model. Each side may have its own hidden state, but the hidden states may be implicitly and/or explicitly synchronized for proper operation (e.g., reconstruction of CSI at the decoder). Similarly, the WTRU may store its hidden states in WTRU's hidden state buffer. The gNB may store its hidden states in gNB's hidden state buffer.

Terms related to hidden states may be defined as follows: a stored hidden state(s) may refer to one or more of hidden state(s) saved in a hidden state buffer. A current hidden state may refer to the hidden state used for inference of current sequence and/or input. By default, the current hidden state may be based on the most recent inference. In some specific cases (e.g., upon hidden state retrieval), the current hidden state may be set to a specific hidden state from the hidden state buffer. An initial hidden state may refer to the hidden state which may be initialized to a preconfigured value (e.g., all zeros and/or random values with a preconfigured pattern and/or distribution or set to predefined value). A hidden state retrieval may refer to the setting of current hidden state to a previously stored hidden state from the hidden state buffer.

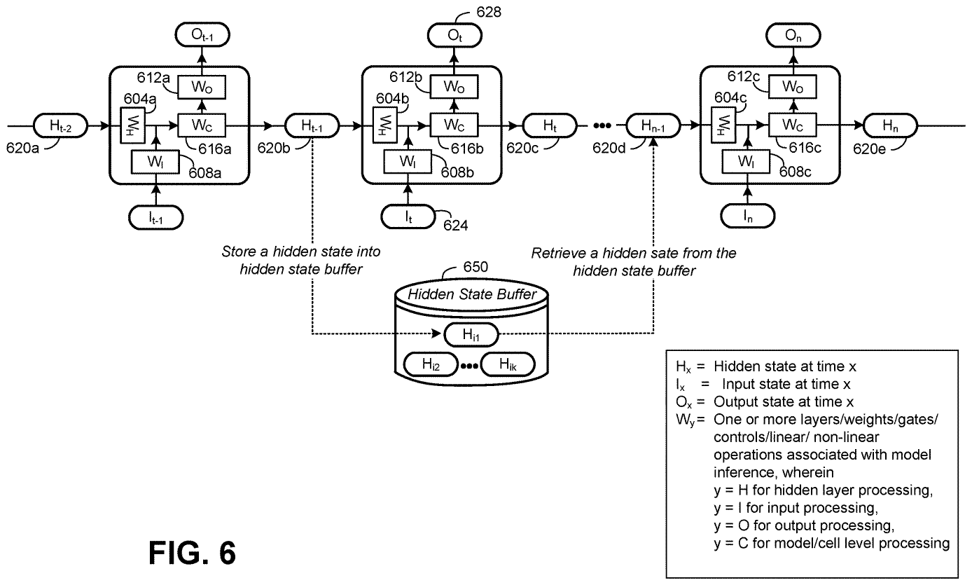

An example realization of the hidden state framework is depicted in FIG. 6. FIG. 6 shows inference at three instances: t−1, t, and n, wherein t−1 and t are consecutive time instances and n is at a future time. The AI/ML model may be generally expressed as tensors W_{H} 604a, b, c W_{I} 608a, b, c, W_{O} 612a, b, c, W_{C} 616a, b, c and/or hidden state Hₓ 620a, b, c, d, e. Possibly the tensors may correspond to layers, weights, gates, controls, and/or non-linear functions (e.g., rectified linear unit (ReLU) and/or, sigmoid, etc.). Depending on the choices and/or design of these tensors, different types of AI/ML model types may apply. It should be noted that FIG. 6 may be an example realization. The techniques described herein may apply for any AI/ML model, architecture, hyperparameter, etc. As shown in the FIG. 6, at time t, the model may take as input tensor Iₜ+624 and/or outputs a tensor Oₜ 628 The output may be a function of input at time t and/or the hidden state at previous time step (e.g., Hₜ₋₁ 620b).

At time t, the model may also generate a hidden state Hₜ 620c. For example, the hidden state Hₜ 620c may store a representation of input at time t and/or representation of the inputs at previous time steps. Based on one or more techniques described herein, the WTRU may store a hidden state in a hidden state buffer 650 based on the first set of conditions and/or retrieve a hidden state based on second set of conditions.

The WTRU may report capability elements associated with hidden state adaptation including explicit indication of maximum hidden state buffer size (e.g., in terms of number of bytes available for hidden state buffer and/or size of each hidden state etc.). In examples, the WTRU may indicate additional granularity in terms of hidden state buffer size per cell, scenario, and/or CSI configuration thereof e.g., bottleneck size, number of antennas, and/or rank, etc.

The WTRU may report capability elements associated with hidden state adaptation. These capability elements may further include implicit indication of maximum hidden state buffer size (e.g., maximum number of hidden states that can be stored in the hidden state buffer, etc.). In examples, the WTRU may indicate additional granularity in terms of hidden state buffer size per cell, scenario, and/or CSI configuration thereof (e.g., bottleneck size, number of antennas, and/or rank, etc.).

The WTRU may report capability elements associated with hidden state adaptation. These capability elements may further include latency of hidden state retrieval (in terms of milliseconds (ms), slots, subframes, and/or frames, etc.); quantization of hidden state before storage into hidden state buffer; preconfigured performance threshold (e.g., SGCS, NMSE, throughput, and/or PDSCH performance etc.); hidden state monitoring and/or observation periodicity (e.g., X ms); and/or configuration for selection and/or transmission of feedback for preferred hidden state and/or hidden state buffer management.

The WTRU may be configured with parameters for hidden state adaptation including one or more of the following: quantization of weights in hidden state, maximum number of hidden states in the hidden state buffer, minimum time between successive hidden state buffer update, minimum time between successive hidden state update, criteria for hidden state storage in hidden state buffer, criteria for hidden state retrieval, maximum number of past samples for hidden state update, and/or validity time associated with stored hidden state.

A WTRU may be configured with procedures for hidden state buffer management. One or more hidden state(s) may learn a representation of underlying channel condition and/or statistics, e.g., based on correlation between successive channel samples. This idea may be leveraged to identify, store, and/or later use the appropriate hidden state for optimal operation of AI/ML model.

The WTRU may add and/or remove hidden state to the hidden state buffer. The WTRU may replace a first hidden state in the hidden state buffer with a second hidden state. The WTRU reset the hidden state buffer. Herein, reset means removing all the hidden state(s) from the hidden state buffer.

The WTRU may divide hidden state buffer logically into sub-buffers, wherein each sub-buffer may associate with a serving cell, configuration, scenario, use case (e.g., CSI compression and/or beam prediction, etc.), a configuration specific use case (e.g., CSI configuration like bottleneck size, number of antennas, and/or rank, etc.). The WTRU may apply more techniques herein at the hidden buffer granularity and/or sub-buffer granularity.

The WTRU may store a hidden state to hidden state buffer when the hidden state satisfies one or more of the following conditions, including a minimum number of time instances of successive RNN operation. In examples, for a hidden state to contain any viable information deemed worth storing and/or retrieving, the RNN in its current state may have operated for at least S1 time instances. Herein, time instances means that the recursive RNN operation has completed for S1 repetitions. If the operation of the RNN has been interrupted and/or reset within less than S1 time instances, the RNN buffer may not be suited for storage in the buffer.

The WTRU may store a hidden state to hidden state buffer when the hidden state satisfies performance metric and/or threshold. The WTRU may store a hidden state in hidden state buffer when the performance of the hidden state meets a preconfigured criteria. To ensure that a newly added hidden state and/or replacing of an existing state meets a minimum performance level, the WTRU may evaluate one or more performance criteria. These performance criteria may include: system performance metrics like PDSCH performance, algorithmic spectral efficiency, bit error rate, and/or prediction performance measurement using normalized mean square error, cosine similarity, and/or an associated performance threshold.

The WTRU may store a hidden state to hidden state buffer when the hidden state satisfies relative performance of a new hidden state. The WTRU may maintain at most top N performing hidden states in the hidden state buffer. The value of N may be preconfigured. The value of N may be a function of WTRU capability. For example, when the performance of a new hidden state exceeds any of the top N hidden states in the hidden state buffer, the WTRU may store the new hidden state in the hidden state buffer.

The WTRU may store a hidden state to hidden state buffer applicable conditions change. For example, the WTRU may add a hidden state to the hidden state buffer when the WTRU detects a change in applicable condition and/or a corresponding hidden state does not exist in the hidden state buffer. The applicable condition may include scenario (e.g., Doppler, and/or WTRU speed, etc.), configuration (antenna configuration, and/or bandwidth etc.), deployment, and/or applicable cell, site, area, zone, and/or WTRU measurement (e.g., rank and/or SNR).

The WTRU may store a hidden state to hidden state buffer upon detection of beam failure and/or radio link failure. For example, the WTRU may trigger hidden buffer update upon identification of blockage event.

The WTRU may store a hidden state to hidden state buffer when the correlation between current channel measurement and/or the channel statistic associated with the hidden state exceeds a preconfigured threshold.

In examples, the WTRU may monitor the criteria associated with hidden state for a preconfigured observation periodicity. The WTRU may be configured with conditions to ensure that the WTRU may not store more than one hidden state associated with the same applicable condition. To avoid duplication, the WTRU may maintain the best performing hidden state for a specific applicable condition. The WTRU may maintain a look back buffer. The WTRU and/or gNB may maintain a S2 length buffer of past channel estimates and/or past hidden states in memory. Herein, S2 may be the look back period and S2>S1. Once the WTRU has determined that a hidden state has to be stored, the WTRU may choose the current state and/or any of the states from the past S2 instances to store in the buffer.

A WTRU may be configured for reporting, feedback, and/or signaling for hidden state buffer updates. In examples, each hidden state may be associated with a context. Each hidden state and/or its context may be associated with a logical identity. The logical identity may uniquely identify the hidden state. The logical identity may be unique among all the hidden states within the WTRU. The logical identity may be derived based on a time component (e.g., slot number, subframe number, and/or frame number, etc.).

The context may include metrics related to inference performance associated with the hidden state. The performance metric may include SGCS, average SGCS, NMSE, average NMSE, BLER threshold, and/or throughput, etc. The context may include the input to the AI/ML model (e.g., raw channel matrix, eigenvector, and/or any preprocessed input thereof). The context may include a statistic associated with the input sample and/or sequence that was used for generation of the hidden state.

Context associated with hidden state may include relevant parameters for buffer management. To explicitly and/or uniquely define a hidden state and/or ensure effective detection and/or retrieval when the need arises, just storing the hidden states independently may be insufficient. Additional parameters may enhance the usability of the hidden states.

Associated channel state information regarding representation of the channel from the current time instant (e.g., when the hidden state was selected for buffering) and/or the few past time instants may be stored. The channel state representation may be in the full channel form, the eigenvector form, and/or in any other form that provides some direct and/or derived information about the channel state.

Performance indicators may include the performance of the ML model for the TSF compression and/or prediction in terms of NMSE, cosine similarity, and/or through any other metric. Additionally or alternatively, the performance of the overall communication setup as the PDSCH performance and/or the bit error rate or through other metrics may also be stored with the hidden state.

The WTRU may associate each hidden state in the hidden state buffer with a logical identity. Such logical identity may be assigned when the WTRU adds the hidden state to the hidden state buffer. Such logical identity may be assigned in the signaling that configures the WTRU to store the hidden state in the hidden buffer. Such logical identity may be a function of time instance that generates the hidden state (e.g., during inference of a sample at time t). Such time instance may be associated with slot, subframe, and/or frame number.

The WTRU may trigger hidden state buffer update based on periodic, aperiodic, semi-persistent and/or based on preconfigured condition. The WTRU may transmit feedback to the gNB indicating what hidden state(s) to store in the hidden state buffer. The WTRU may send such indication when the WTRU updates its own local hidden state buffer. The WTRU may transmit the feedback when one or more conditions for hidden state buffer updates exist. The WTRU may indicate the hidden state based on logical identity associated with the hidden state. The WTRU may indicate a relative time offset to the hidden state. The relative time offset may indicate the time of inference during which the hidden state was generated. The relative time offset may indicate the slot, subframe, frame, and/or at which the CSI report was transmitted, wherein the CSI report may be generated by the hidden state. The relative time offset may indicate the slot, subframe, frame and/or where the CSI-RS associated with the input sequence which generated the hidden state.

The WTRU may report the identity of hidden state and/or the context associated with the hidden state to the NB.

The WTRU may transmit the feedback as part of the CSI report. For example, the CSI report may comprise two parts. The first part may include hidden state buffer update feedback. The second part may include the compressed CSI feedback using the RNN encoder model. The WTRU may transmit the hidden state buffer update feedback via UCI and/or in a PUSCH resource and/or in MAC CE. The WTRU may transmit the TSF feedback in a PUSCH resource while the CSI feedback via UCI.

A WTRU may be preconfigured with one or more rules to determine the hidden state to use and/or apply for inference. The WTRU may use the hidden state based on the most recent inference (e.g., t−1) as the hidden state for inference of current sequence/input at time t.

A WTRU may be configured with triggers for initializing and/or resetting hidden state to a preconfigured value. The WTRU may set (e.g., initialize and/or reset) the hidden state to a preconfigured value when one or more conditions are satisfied. The WTRU may set the hidden state to a preconfigured value when the AI/ML model is activated for inference. The AI/ML model may be in a deactivated state before activation. The WTRU may set the hidden state to a preconfigured value when the WTRU performs RRC reconfiguration. The WTRU may perform RRC reconfiguration with sync. The WTRU may set the hidden state to preconfigured value when the WTRU performs re-establishment. The WTRU may set the hidden state to preconfigured value when the WTRU transitions from IDLE to CONNECTED state.

The WTRU may set a hidden state to a retrieved hidden state from a hidden state buffer when one or more trigger conditions are satisfied. The applicable condition may include scenario (e.g., Doppler and/or WTRU speed etc.), configuration (e.g., antenna configuration, bandwidth etc.), deployment, applicable cell, site, area, and/or zone, and/or WTRU measurement (e.g., rank and/or SNR), etc. The WTRU may trigger hidden state retrieval when the applicable conditions change and/or there exists a hidden state whose context and/or applicable condition matches with the current applicable condition.

Applicable conditions may also occur upon detection of beam failure and/or radio link failure. For example, the WTRU may trigger hidden state update upon identification of a blockage event. Applicable conditions may also occur when the correlation between current channel measurement and/or the channel statistic associated with the hidden state exceeds a preconfigured threshold.

The WTRU may trigger the retrieval based on one or multiple performance metrics. For example, the performance may include poor PDSCH performance for at least R1 time instants slots or transmission time intervals (TTIs), (e.g., the number of NACKs within R1 TTIs exceeds a preconfigured threshold) where R1 may be configured by the network. The performance metrics may include large changes in the channel correlation, changes in channel derived metrics like Doppler, delay spread, etc.

Based on the performance metrics, the WTRU may initiate the retrieval process. In the retrieval process, the WTRU may self identify the optimal hidden state to retrieve an explicit state. The gNB may define the explicit state to be retrieved. For self-determination, the WTRU may employ methods to check the similarity between the current channel state and the buffered channel states, corresponding to each of the hidden states. The similarity may be evaluated in terms of channel state cross correlation, evaluating the cosine similarity, the normalized errors, and/or through any other metric. Amongst past states where correlation, SGCS, and/or other metrics indicate a similarity above a threshold level, the most similar one may be selected. The current RNN hidden state may be flushed and/or replaced with the selected state.

When reporting, providing feedback, and/or signaling for a hidden state update, the WTRU may configure the hidden state to all zeros. The WTRU may set the hidden state to identity matrix. The WTRU may set the hidden state to a random value with a preconfigured distribution. The WTRU may set the hidden state to a random value based on a pseudorandom sequence generator. The pseudorandom sequence generator parameters may be preconfigured. The pseudorandom sequence generator may be initialized with a seed value. The seed value may be a function of slot, subframe, and/or frame number. The hidden state may be set to a preconfigured value wherein the value may be a function of training outcome and/or dataset. The training may be offline or online. The hidden state may be set to a predefined value. The predefined value may be a function of scenario, use case, configuration, deployment, and/or cell and/or area, etc.

The WTRU may set the hidden state to a value explicitly signaled from the gNB. Such value may be signaled in a RRC configuration. The WTRU may be preconfigured to a plurality of hidden state value and/or each hidden state value may be associated with a logical identity. The WTRU may set the hidden state to a value based on the logical identity received from the gNB. Such logical identity may be signaled in RRC message, MAC CE, and/or in a DCI.

The WTRU may set the hidden state based on the hidden state retrieved from the hidden state buffer. The WTRU may associate each hidden state in the hidden state buffer with a logical identity. Such a logical identity may be assigned when the WTRU adds the hidden state to the hidden state buffer. Such a logical identity may be assigned in the signaling that configures the WTRU to store the hidden state in the hidden buffer. Such a logical identity may be a function of time instance that generates the hidden state (e.g., during inference of a sample at time t). Such time instance may be associated with slot, subframe, and/or frame number.

Upon setting the hidden state value based on one or more examples herein, the WTRU may use that hidden state for subsequent inference. The WTRU may use the hidden state for the generation of the next output. The WTRU may use the hidden state to generate CSI report or parts thereof.

Hidden state storage may be synched at WTRU and/or gNB. The WTRU may send a request to gNB to update its buffer with a new hidden state (e.g., when determining that a new hidden state needs to be added to the buffer and/or an existing hidden state needs to be replaced). The WTRU may additionally specify the time stamp of the exact time instant at which the hidden state should be buffered.

The WTRU may trigger hidden state update based on periodic, aperiodic, semi-persistent and/or based on preconfigured condition. The WTRU may transmit the feedback as part of the CSI report. The CSI report may comprise two parts. The first part may include hidden state buffer update feedback. The second part may include the compressed CSI feedback using the RNN encoder model. The WTRU may transmit the hidden state update feedback via UCI and/or in a PUSCH resource and/or in MAC CE. The WTRU may transmit the hidden state buffer feedback in a PUSCH resource while the hidden state updates feedback via UCI.

During the hidden state retrieval, the retrieval may be carried out based on the channel state and/or hidden state at the current time instant, in which case the hidden state may be directly utilized for RNN processing. Additionally or alternatively, the WTRU and/or gNB may identify a past time instant at which the hidden state retrieval and/or plugin becomes more beneficial than using the current hidden state (e.g., that results in lower reconstruction error). The WTRU and/or gNB may determine a past channel state which has a high degree of similarity (e.g., high SGCS) with the current state, where the past channel states and/or the corresponding hidden states may be available in the channel/hidden state buffer. The WTRU may then use the determined past channel state to determine the past hidden state for retrieval.

To enable this processing, the WTRU and/or gNB may maintain R2 past channel estimates and/or hidden states in memory, where R2 may be the maximum allowable look back period. If any of the past [t−R2 to t−1] channels has a greater similarity with the current channel (e.g., SGCS value exceeding a configured threshold), then the RNN may be restored with the selected hidden state and/or past set of channel states corresponding to the index t−R3 of the channel state that maximizes the SGCS. The value of R3 may be in the range of 1 to R2, or it may be zero if the SGCS values corresponding to all past [t−R2 to t−1] channels are below the configured threshold. Any of the past channels (starting from index t−R3) leading up to the current time instant may be again compressed with the newly selected hidden state. Thus, starting from the selected instant (e.g., t−R3) the set of channels in the range (e.g., [t−R3 to t−1]) may be recompressed.

The compressed representation associated with the past R3 channels may be re-sent to the gNB. The gNB may restore the same hidden state and/or run the RNN with the restored state and/or the past R3 channels to reach the current channel. If R3=0, may be the equivalent to having no additional transmissions of past channels. Having R3=0 may require just the reset of hidden state at both WTRU and/or gNB.

A WTRU performing TSF domain compression may determine and/or report preferred hidden buffer states. The configuration may include: maximum hidden buffer size (e.g., the maximum number of hidden states to store, wherein hidden state X denotes an intermediate and/or hidden representation of a sequence of X historical CSI samples (e.g., raw CSI or eigenvector); TSF parameters (e.g., TSF buffer maximum size); preconfigured performance threshold (e.g., TSF and/or SGCS); hidden states monitoring and/or observation periodicity (e.g., X ms); activation for selecting and/or recommending the preferred hidden state.

The WTRU may determine a set of preferred hidden state(s) to store in the hidden state buffer based on, SGCS performance, identified blockage event, PDSCH performance, and/or observation periodicity. The WTRU may update performance information (e.g., SGCS) associated with each preferred hidden state. The WTRU may determine an update (e.g., add, remove, and/or replace) to a preferred hidden state (e.g., based on WTRU speed or a configured periodicity for a hidden state to become obsolete).

The WTRU may determine which hidden state to revisit and/or apply (e.g., based on the measured correlation coefficient relative to the configured threshold and/or based on the measured performance at each state). The WTRU may calculate the compressed CSI based on the selected hidden state. The WTRU may report an indication for the preferred hidden states and associated parameters (e.g., associated performance, state update message, and/or hidden state ID) to update the hidden state buffer. The WTRU may report an indication that includes the selected hidden state to apply (e.g., selected state ID, and/or performance, etc.) The WTRU may report the compressed CSI using the selected hidden state.

A WTRU may detect and/or mitigate of out-of-sync events (e.g., misalignment between WTRU and/or NW TSF buffers) by WTRUs performing TSF domain CSI compression. The WTRU performing TSF domain compression may detect and/or report out-of-sync events. For example, the configuration may include: network performance indicators (e.g., an SGCS measured at gNB between first and last samples in the gNB buffer); an out-of-sync performance threshold; an out-of-sync periodicity (e.g., every X ms WTRU takes an action); and/or an indication for synchronization monitoring.

The WTRU may be triggered to perform measurements, which may be used for out-of-sync detection and mitigation. The WTRU may determine that an out-of-sync event occurred (e.g., based on comparing the measured SGCS at the WTRU) and/or the indicated SGCS from the network, (e.g., when the mismatch exceeds the configured performance threshold).

Upon detecting an out-of-sync event, the WTRU may switch to/recommend another compression mode (e.g., SF or another CSI feedback); and/or partially flush the hidden buffer (e.g., by keeping the newest N samples, where N is less than or equal to the max buffer size).

Upon detecting an out-of-sync event, the WTRU may indicate detection of an out-of-sync event; the WTRU's behavior for out-of-sync mitigation (e.g., compression mode switching, buffer flush of N samples, etc.); and/or a performance metric for out-of-sync monitoring (e.g., SGCS between first and/or last samples in the WTRU buffer).

A WTRU configuration information may be associated with temporal-spatial-frequency (TSF) compression. The WTRU may measure channel state information (CSI). The WTRU may determine TSF parameters based on the configuration information and the measured CSI. The WTRU may calculate a compressed CSI based on the measured CSI and the determined TSF parameters. The WTRU may send the determined TSF parameters and the compressed CSI in a CSI measurement report.

The configuration information may include an indication of one or more of a maximum TSF buffer size, an initial compression ratio, and/or a metric threshold. The TSF parameters may include one or more of a TSF buffer size, a TSF buffer performance indicator, a TSF buffer state, a compression rate, and/or a CSI input domain. The TSF parameters may be based on a measured correlation metric, a configured threshold, a measure of WTRU speed, and/or a measure of physical downlink shared channel (PDSCH) performance.

The metric threshold may include a measurement of a squared generalized cosine similarity (SGCS) between consecutive samples in the TSF buffer as compared to a TSF SGCS threshold. The metric threshold may include a measurement of a SGCS between first and last samples in the TSF buffer as compared to a TSF SGCS threshold.

The measure of WTRU speed may be based on an estimated Doppler, a feedback delay, and/or a CSI processing time. The measure of PDSCH performance may be based one or more of a measured block error rate (BLER) or a measured number of consecutive acknowledgments or negative acknowledgments (ACK/NACK). The TSF buffer contains eigenvector samples or full CSI samples. The WTRU may store the measured CSI in a TSF buffer.

What is claimed is:

1.-20. (canceled)

21. A method performed by a wireless transmit/receive unit (WTRU), the method comprising:
receiving configuration information, the configuration information associated with preferred hidden buffer states for temporal-spatial-frequency (TSF) compression, wherein the configuration information comprises a maximum hidden state buffer, one or more TSF parameters, a preconfigured performance threshold, a hidden buffer state monitoring periodicity, or an activation command to update a set of preferred hidden buffer states;
determining the set of preferred hidden buffer states based on a plurality of historical channel state information (CSI) measurements and the configuration information, wherein the set of preferred hidden buffer states is determined based on squared generalized cosine similarity (SGCS) performance, an identified blockage event, physical downlink shared channel (PDSCH) performance, or an observation periodicity;
determining a preferred hidden buffer state out of the determined set of preferred hidden buffer states based on a measured performance metric and the preconfigured performance threshold;
calculating compressed CSI based on the determined preferred hidden buffer state; and
sending an indication of the preferred hidden buffer state used to compress the CSI to a network.

22. The method of claim 21, further comprising sending an indication of the set of preferred hidden buffer states to the network.

23. The method of claim 21, further comprising selecting one or more hidden buffer states to update based on a measured correlation coefficient relative to a configured threshold or based on a measured performance at each hidden buffer state.

24. The method of claim 23, further comprising:
updating the set of preferred hidden buffer states based on the measured correlation coefficient relative to the configured threshold or based on the measured performance at each hidden buffer state;
storing the updated set of preferred hidden buffer states in a hidden TSF buffer; and
sending an indication of the updated set of preferred hidden buffer states to the network.

25. The method of claim 21, wherein the one or more TSF parameters comprise one or more of: a number of buffer samples, a TSF buffer state, a compression rate (CR), a TSF max buffer size, a TSF buffer performance indicator, or an input domain.

26. The method of claim 21, further comprising storing a new hidden buffer state to the set of preferred hidden buffer states in a hidden TSF buffer when a number of time instances of successive recurrent neural network (RNN) operations is greater than a threshold.

27. The method of claim 21, further comprising storing a new hidden buffer state to the set of preferred hidden buffer states in a hidden TSF buffer when a beam failure or a radio failure is detected.

28. The method of claim 21, wherein each of the preferred hidden buffer states comprises one or more of: an intermediate representation of an input sequence, an internal memory state, a set of activations associated with one or more layers, or a state in a Markov decision process.

29. The method of claim 21, further comprising storing one or more hidden states in a hidden buffer, wherein each hidden state comprises an intermediate representation of an input CSI sequence.

30. A wireless transmit/receive unit (WTRU) comprising:
a processor configured to:
receive configuration information, the configuration information associated with preferred hidden buffer states for temporal-spatial-frequency (TSF) compression, wherein the configuration information comprises a maximum hidden state buffer, one or more TSF parameters, a preconfigured performance threshold, a hidden buffer state monitoring periodicity, or an activation command to update a set of preferred hidden buffer states;
determine the set of preferred hidden buffer states based on a plurality of historical channel state information (CSI) measurements and the configuration information, wherein the set of preferred hidden buffer states is determined based on squared generalized cosine similarity (SGCS) performance, an identified blockage event, physical downlink shared channel (PDSCH) performance, or an observation periodicity;
determine a preferred hidden buffer state out of the determined set of preferred hidden buffer states based on a measured performance metric and the preconfigured performance threshold;
calculate compressed CSI based on the determined preferred hidden buffer state; and
send an indication of the preferred hidden buffer state used to compress the CSI to a network.

31. The WTRU of claim 30, wherein the processor is further configured to send an indication of the set of preferred hidden buffer states to the network.

32. The WTRU of claim 30, wherein the processor is further configured to select one or more hidden buffer states to update based on a measured correlation coefficient relative to a configured threshold or based on a measured performance at each hidden buffer state.

33. The WTRU of claim 32, wherein the processor is further configured to:
update the set of preferred hidden buffer states based on the measured correlation coefficient relative to the configured threshold or based on the measured performance at each hidden buffer state;
store the updated set of preferred hidden buffer states in a hidden TSF buffer; and
send an indication of the updated set of preferred hidden buffer states to the network.

34. The WTRU of claim 30, wherein the one or more TSF parameters comprise one or more of: a number of buffer samples, a TSF buffer state, a compression rate (CR), a TSF max buffer size, a TSF buffer performance indicator, or an input domain.

35. The WTRU of claim 30, wherein the processor is further configured to store a new hidden buffer state to the set of preferred hidden buffer states in a hidden TSF buffer when a number of time instances of successive recurrent neural network (RNN) operations is greater than a threshold.

36. The WTRU of claim 30, wherein the processor is further configured to store a new hidden buffer state to the set of preferred hidden buffer states in a hidden TSF buffer when a beam failure or a radio failure is detected.

37. The WTRU of claim 30, wherein each of the preferred hidden buffer states comprises one or more of: an intermediate representation of an input sequence, an internal memory state, a set of activations associated with one or more layers, or a state in a Markov decision process.

38. The WTRU of claim 30, wherein the processor is further configured to store one or more hidden states in a hidden buffer, wherein each hidden state comprises an intermediate representation of an input CSI sequence.
